(19) United States
(12) Patent Application Publication
(10) Pub. No.: US 2005/0159541 A1
(43) Pub. Date: Jul. 21, 2005

(54) Size composition

(75) Inventors: Thorsten Rische, Unna (DE); Thomas Feller, Solingen (DE); Jurgen Meixner, Krefeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/034,112

(22) Filed: Jan. 12, 2005

(30) Foreign Application Priority Data
Jan. 16, 2004 (DE) 1020040025274

(51) Int. Cl. C08K 3/20; C08K 3/40; C08K 9/00

(52) U.S. Cl. 524/591; 524/494; 523/217

(57) ABSTRACT

Size compositions that include one or more polyurethane-polyurea dispersions; optionally further film-forming resins; and optionally crosslinkers. The dispersions are obtained by preparing an NCO-containing polyurethane prepolymer by reacting polyisocyanates with polymeric polyols and/or polyamines, optionally low molecular weight compounds, isocyanate-reactive, ionically or potentially ionically hydrophilicizing compounds and/or isocyanate-reactive nonionically hydrophilicizing compounds, and optionally in inert solvents with the proviso that none of components contains primary or secondary amino groups; followed by either dissolving the prepolymer in aliphatic ketones or, diluting the prepolymer solution by further addition of aliphatic ketones; and reacting the remaining free NCO groups of the prepolymer with a chain extender component. The dispersions are used in mouldings and/or coatings that can be used to caot substrates, such as glass fibers.

### CROSS REFERENCE TO RELATED PATENT APPLICATION

The present patent application claims the right of priority under 35 U.S.C. § 119 (a)-(d) of German Patent Application No. 10 2004 002 527.4, filed Jan. 16, 2004.

### BACKGROUND OF THE INVENTION

1. Field of the Invention

The invention relates to new size compositions, stable to thermal yellowing, and also to their preparation and use.

2. Description of the Prior Art

In the sizing of glass and carbon fibres use is made inter alia, as in EP-A 792 900, for example, of PU dispersions as binders in the size composition.

Owing to the comparatively high temperatures involved in the coating and drying operations and also in the compounding of the sized glass fibre into a polymer matrix, which may in some cases be much more than 200° C., unwanted thermal yellowing of the coatings produced is a frequent occurrence.

The prior art has disclosed numerous stabilizers and additives which are able to reduce thermal yellowing of binders. In the field of aqueous PU dispersion, however, the inhibitory effect of these systems on yellowing is inadequate or they lead to poorer performance properties of the dispersions and coatings, such as poorer stress-strain behaviour or poor compatibilities with other coating or sizing components. The known additives are also prone to migration from the coatings produced, so that, over time, unwanted fogging and a tailing off in the yellowing stabilization comes about.

U.S. Pat. No. 5,137,967 describes the preparation of carboxylate-containing PU dispersions which are stable with respect to thermal yellowing and are prepared by the method known as the prepolymer mixing method. For yellowing stabilization, hydrazine is used to chain-extend the prepolymer and dimethylaminoethanol (DMAE) is used as the neutralizing amine for the carboxylic acid groups.

DE 32 38 169 describes a process for preparing PU dispersions which uses hydrazine or hydrazides as additives or as chain extenders. Exclusively anionic, carboxylate-finctional PU dispersions by the prepolymer mixing method are described.

Hydrazines and hydrazides as chain extenders in polyurethanes are known in principle, for example, from U.S. Pat. No. 4,147,679 or DE-A 23 14 513. In some cases they are also used in mixtures with other chain extenders such as diamines (U.S. Pat. No. 3,415,768). They serve to improve flexibility, hardness, resistance and drying of the coatings.

The object of the present invention, then, was to provide size compositions stable to or low in thermal yellowing in comparison to prior art sizes.

### SUMMARY OF THE INVENTION

The present invention is directed to size compositions that include I) one or more polyurethane-polyurea dispersions (PU dispersions); II) optionally further film-forming resins; and III) optionally crosslinkers. The PU dispersions in I) are obtained by A) preparing an NCO-containing polyurethane prepolymer by reacting A1) polyisocyanates with A2) polymeric polyols and/or polyamines having number-average molecular weights of 400 to 8000 g/mol, A3) optionally low molecular weight compounds having number-average molecular weights of 17-400 g/mol selected from the group consisting of mono- and polyalcohols, mono- and polyamines and also amino alcohols, A4) isocyanate-reactive, ionically or, potentially ionically hydrophilicizing compounds and/or A5) isocyanate-reactive nonionically hydrophilicizing compounds A6) optionally in inert solvents with the proviso that none of components A1) to A5) contains primary or secondary amino groups; B) either dissolving the prepolymer obtained from step A) in aliphatic ketones or, diluting the prepolymer solution if preparation has already been carried out in inert solvents, optionally by further addition of aliphatic ketones, and C) reacting the remaining free NCO groups of the prepolymer with a chain extender component that includes C1) hydrazine and/or hydrazine hydrate and C2) optionally compounds meeting the definition of components A2), A3), A4) and/or A5), with the proviso that the compounds of component C2) contain primary and/or secondary amino groups, the total amounts of C1) and C2) are such that an arithmetic degree of chain extension of 40 to 200% is attained and the proportion of C1) and C2) is such that at least 40% of the free isocyanate groups are terminated by and/or chain-extended with amino groups from component C1).

The present invention also provides mouldings and/or coatings that contain the above-described size compositions and one or more additives selected from coupling agents, lubricants, antistats, dyes, pigments, flow assistants, light stabilizers, aging inhibitors, UV absorbers, and combinations thereof.

The present invention further provides substrates coated with coatings produced using size compositions described above.

The present invention additionally provides glass fibres wherein the above described size compositions are applied to the glass fibers.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The present invention provides size compositions that are stable to or low in thermal yellowing in comparison to prior art sizes.

Thus, It has been found that sizes based on specifically prepared PU dispersions using hydrazine as chain extender component fulfill the desired properties without the addition of special external stabilizers/additives.

The present invention accordingly provides size compositions comprising
I) one or more polyurethane-polyurea dispersions (PU dispersions)
II) optionally further film-forming resins
III) optionally crosslinkers
IV) auxiliaries and additives,
   characterized in that the PU dispersions used in I) are obtainable by
A) first preparing an NCO-containing polyurethane prepolymer by reacting
   A1) polyisocyanates with
   A2) polymeric polyols and/or polyamines having number-average molecular weights of 400 to 8000 g/mol,
   A3) optionally low molecular weight compounds having number-average molecular weights of 17-400 g/mol selected from the group consisting of mono- and polyalcohols, mono- and polyamines and also amino alcohols,
   A4) isocyanate-reactive, ionically or potentially ionically hydrophilicizing compounds and/or
   A5) isocyanate-reactive nonionically hydrophilicizing compounds
   A6) optionally in aliphatic ketones as solvents
      with the proviso that none of components A1) to A5) contains primary or secondary amino groups,
B) either dissolving the prepolymer obtained from step A) in aliphatic ketones or, if preparation has already been carried out in the presence of A6), diluting the prepolymer solution optionally by further addition of aliphatic ketones, and
C) reacting the remaining free NCO groups of the prepolymer with a chain extender component comprising
   C1) hydrazine and/or hydrazine hydrate and
   C2) optionally compounds meeting the definition of components A2), A3), A4) and/or A5),
   with the proviso that
   the compounds of component C2) contain primary and/or secondary amino groups,
   the total amounts of C1) and C2) are such that an arithmetic degree of chain extension of 40 to 200% is attained and
   the proportion of C1) and C2) is such that at least 40% of the free isocyanate groups are terminated by and/or chain-extended with amino groups from component C1).

Suitable polyisocyanates of component A1) are the aromatic, araliphatic, aliphatic or cycloaliphatic polyisocyanates which are known per se to the skilled person, and which may also contain iminooxadiazinedione, isocyanurate, uretdione, urethane, allophanate, biuret, urea, oxadiazinetrione, oxazolidinone, acylurea and/or carbodiimide structures. They may be used in A1) individually or in any desired mixtures with one another.

Examples of suitable aromatic, araliphatic, aliphatic or cycloaliphatic polyisocyanates are di- and/or triisocyanates of the molecular weight range 140 to 400 g/mol which are obtainable by phosgenation or by phosgene-free processes, as by thermal urethane cleavage, for example, and which contain aliphatically, cycloaliphatically, araliphatically and/or aromatically attached isocyanate groups, such as 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (Desmodur® W, Bayer AG, Leverkusen), 4-isocyanatomethyl-1,8-octane diisocyanate (triisocyanatononane, TIN), ω, ω′-diisocyanato-1,3-dimethylcyclohexane (H₆XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanatoprop-2-yl)benzene (TMXDI), 2,4- and 2,6-diisocyanatotoluene (TDI) in particular the 2,4 and the 2,6 isomers and technical-grade mixtures of the two isomers, 2,4′- and 4,4′-diisocyanatodiphenylmethane (MDI), 1,5-diisocyanatonaphthalene, 1,3-bis(isocyanatomethyl)benzene (XDI) and any desired mixtures of the said compounds.

Preference is given to using in A1) polyisocyanates or polyisocyanate mixtures of the aforementioned kind containing exclusively aliphatically and/or cycloaliphatically attached isocyanate groups.

Particular preference is given to hexamethylene diisocyanate, isophorone diisocyanate and the isomeric bis(4,4′-isocyanatocyclohexyl)methanes and also to mixtures thereof.

It is important that for preparing the prepolymer the compounds used in A2)-A5) are only such as contain no primary and/or secondary amino functions. In the context of the chain extension, in contrast, it is possible in C2) to use compounds which meet the definitions of components A2)-A5) but which additionally contain primary and/or secondary amino groups.

Polymeric polyols or polyamines meeting the definition of component A2) come typically from the group consisting of polyacrylates, polyesters, polylactones, polyethers, polycarbonates, polyester carbonates, polyacetals, polyolefins and polysiloxanes and possess preferably a functionality relative to NCO-reactive functionalities of 1.5 to 4.

Particularly preferred polymeric polyols are those of the aforementioned kind having a number-average molecular weight of 600 to 2500 g/mol and having an OH functionality of 2 to 3.

Hydroxyl-containing polycarbonates meeting the definition of component A2) are obtainable by reacting carbonic acid derivatives, e.g. diphenyl carbonate, dimethyl carbonate or phosgene, with diols.

Examples of suitable such diols include ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A or else lactone-modified diols. Preferably the diol component contains 40 to 100% by weight of hexanediol, preferably 1,6-hexanediol and/or hexanediol derivatives, with particular preference derivatives which in addition to terminal OH groups contain ether or ester groups, such as products obtained by reacting 1 mol of hexanediol with at least 1 mol, preferably 1 to 2 mol, of caprolactone as in DE-A 17 70 245 or by etherifying hexanediol with itself to form the di- or trihexylene glycol. The preparation of such derivatives is known, for example, from DE-A 15 70 540. The polyether-polycarbonate diols described in DE-A 37 17 060, as well, can be used.

The hydroxyl polycarbonates are preferably linear, but may also be branched where appropriate as a result of the incorporation of polyfunctional components, especially low molecular weight polyols. Examples of those suitable for this purpose include glycerol, trimethylolpropane, hexane-1,2,6-triol, butane-1,2,4-triol, trimethylolpropane, pentaerythritol, quinitol, mannitol, and sorbitol, methylglycoside, and 1,3,4,6-dianhydrohexitols.

Suitable polyether polyols meeting the definition of component A2) are the polytetramethylene glycol polyethers which are known per se in polyurethane chemistry and can be prepared, for example, via polymerization of tetrahydrofuran by cationic ring opening.

Additionally suitable polyether polyols are polyethers, such as the polyols, prepared using starter molecules, of styrene oxide, propylene oxide, butylene oxides or epichlorohydrin, particularly of propylene oxide.

Examples of suitable polyester polyols meeting the definition of component A2) include reaction products of polyhydric, preferably dihydric and optionally additionally trihydric alcohols with polybasic, preferably dibasic, carboxylic acids. Instead of the free polycarboxylic acids it is also possible to use the corresponding polycarboxylic anhydrides or corresponding polycarboxylic esters of low alcohols or mixtures thereof to prepare the polyesters. The polycarboxylic acids may be aliphatic, cycloaliphatic, aromatic and/or heterocyclic in nature and may optionally be substituted, by halogen atoms for example, and/or unsaturated.

In the process of the invention it is possible to add compounds meeting the definition of component A3) for terminating the polyurethane prepolymer.

Compounds suitable for this purpose are, for example, aliphatic monoalcohols or monoamines of the stated molecular weight range having 1 to 18 carbon atoms, such as ethanol, n-butanol, ethylene glycol monobutyl ether, 2-ethylhexanol, 1-octanol, 1-dodecanol, 1-hexadecanol, diethylamine, dibutylamine, ethanolamine, N-methylethanolamine, N,N-diethanolamine, amines of the Jeffamine® M series (Huntsman Corp. Europe, Belgium) or amino-functional polyethylene oxides and polypropylene oxides.

In addition it is possible to use polyols, amino polyols or polyamines having a number-average molecular weight below 400 g/mol in the process of the invention. Those that may be mentioned by way of example include:
a) alkanediols and/or -triols, such as ethanediol, 1,2- and 1,3-propanediol, 1,4- and 2,3-butanediol, 1,5-pentanediol, 1,3 dimethylpropanediol, 1,6-hexanediol, neopentyl glycol, 1,4-cyclohexanedimethanol, 2-methyl-1,3-propanediol, 2-ethyl-2-butylpropanediol, trimethylpentanediol, positionally isomeric diethyloctanediols, 1,2- and 1,4-cyclohexanediol, hydrogenated bisphenol A [2,2-bis(4-hydroxycyclohexyl)propane], (2,2-dimethyl-3-hydroxypropyl) 2,2-dimethyl-3-hydroxypropionate, trimethylolethane, trimethylolpropane or glycerol,
b) ether diols, such as diethylene diglycol, triethylene glycol, tetraethylene glycol, dipropylene glycol, tripropylene glycol, 1,3-butylene glycol or hydroquinone dihydroxyethyl ether,
c) ester diols of the general formulae (I) and (II),
   HO—(CH₂)ₓ—CO—O—(CH₂)_{y}—OH (I),
   HO—(CH₂)ₓ—O—CO—R—CO—O(CH₂)ₓ—OH (II),
   in which
R is an alkylene or arylene radical having 1 to 10 carbon atoms, preferably 2 to 6 carbon atoms,
x is 2 to 6 and
y is 3 to 5,
   such as, for example, δ-hydroxybutyl-ε-hydroxy-caproic esters, ω-hydroxyhexyl-γ-hydroxybutyric esters, β-hydroxyethyl adipate and bis(β-hydroxyethyl)terephthalate, and
d) di- and polyamines such as 1,2-diaminoethane, 1,3-diaminopropane, 1,6-diaminohexane, 1,3- and 1,4-phenylenediamine, 4,4′-diphenylmethanediamine, isophoronediamine, isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine, 4,4-diaminodicyclohexylmethane, amino-finctional polyethylene oxides or polypropylene oxides, which are available under the name Jeffamine®, D series (Huntsman Corp. Europe, Belgium), diethylenetriamine and triethylenetetramine. Further suitable diamines in the sense of the invention include substituted hydrazines, such as N-methylhydrazine, N,N′-dimethylhydrazine and homologs thereof and also acid dihydrazides of adipic acid, β-methyladipic acid, sebacic acid, hydracrylic acid and terephthalic acid, semicarbazido-alkylene hydrazides, such as β-semicarbazidopropionic hydrazide (e.g. described in DE-A 17 70 591), semicarbazidoalkylene-carbazine esters, such as 2-semicarbazidoethylcarbazine ester (e.g. described in DE-A 19 18 504) or else aminosemicarbazide compounds, such as β-aminoethylsemicarbazidocarbonate (e.g. described in DE-A 19 02 931), for example.

By ionically and potentially ionically hydrophilicizing compounds are meant all compounds which contain at least one isocyanate-reactive group and also at least one functionality, such as —COOY, —SO₃Y, —PO(OY)₂ (Y for example=H, NH₄⁺, metal cation), —NR₂, —NR₃⁺ (R=H, alkyl, aryl), which on interaction with aqueous media enters into an optionally pH-dependent dissociation equilibrium and in that way can have a negative, positive or neutral charge.

Preferred isocyanate-reactive groups are hydroxyl or amino groups.

Suitable ionically or potentially ionically hydrophilicizing compounds meeting the definition of component A4 are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and salts thereof such as dimethylolpropionic acid, dimethylolbutyric acid, hydroxypivalic acid, N-(2-aminoethyl)-β-alanine, 2-(2-aminoethylamino)ethanesulphonic acid, ethylenediaminepropyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and the alkali metal and/or ammonium salts thereof; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and compounds which contain building blocks which can be converted into cationic groups, amine-based building blocks for example, such as N-methyldiethanolamine, as hydrophilic synthesis components. It is also possible to use cyclohexylaminopropanesulphonic acid (CAPS) such as in WO 01/88006, for example, as a compound meeting the definition of component A4).

Preferred ionic or potential ionic compounds are those which possess carboxyl or carboxylate and/or sulphonate groups and/or ammonium groups.

Particularly preferred ionic compounds are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Suitable nonionically hydrophilicizing compounds meeting the definition of component A5) are, for example, polyoxyalkylene ethers containing at least one hydroxyl or amino group. These polyethers include a fraction of 30% to 100% by weight of building blocks derived from ethylene oxide. Those suitable include polyethers of linear construction with a finctionality of between 1 and 3, but also compounds of the general formula (III) 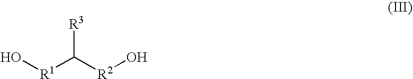
in which
R¹ and R² independently of one another are each a divalent, aliphatic, cycloaliphatic or aromatic radical having 1 to 18 carbon atoms, which may be interrupted by oxygen and/or nitrogen atoms, and
R³ is an alkoxy-terminated polyethylene oxide radical.

Nonionically hydrophilicizing compounds also include, for example, monohydric polyalkylene oxide polyether alcohols containing on average 5 to 70, preferably 7 to 55, ethylene oxide units per molecule, such as are obtainable in conventional manner by alkoxylating appropriate starter molecules (e.g. in Ullmanns Encyclopädie der technischen Chemie, 4th edition, Volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers such as diethylene glycol monobutyl ether, for example, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine and also heterocyclic secondary amines such as morpholine, pyrrolidine, piperidine or 1H-pyrazole. Preferred starter molecules are saturated monoalcohols. Particular preference is given to using diethylene glycol monobutyl ether as starter molecule.

Alkylene oxides suitable for the alkoxylation reaction are, in particular, ethylene oxide and propylene oxide, which may be used in any order or else as a mixture in the alkoxylation reaction.

The polyalkylene oxide polyether alcohols are either straight polyethylene oxide polyethers or mixed polyalkylene oxide polyethers at least 30 mol %, preferably at least 40 mol %, of whose alkylene oxide units are composed of ethylene oxide units. Preferred nonionic compounds are monofunctional mixed polyalkylene oxide polyethers containing at least 40 mol % ethylene oxide units and not more than 60 mol % propylene oxide units.

In the process it is preferred to use a combination of ionic and nonionic hydrophilicizing agents meeting the definitions of components A4) and A5).

Particularly preferred combinations are those of nonionic and anionic hydrophilicizing agents.

Chain extension in step C) is carried out using hydrazine and/or its hydrates as component C1). Preference is given to using hydrazine monohydrate.

If desired it is also possible in component C2) to use further chain extenders. These meet the above definitions of the compounds suitable for A2)-A5) with the proviso that the compounds used in C2) contain —NH₂ and/or NH groups.

In the process it is preferred to use 7 to 45% by weight of component A1), 50 to 91% by weight of component A2), 0 to 30% by weight of compounds A3), 0 to 12% by weight of component A4), 0 to 15% by weight of component A5), 0.1 to 5.0% by weight of C1) (based on pure hydrazine, N₂H₄) and 0 to 15% by weight of C2), the sum of A4) and A5) being 0.1 to 27% by weight and the sum of all the components adding to 100% by weight.

Use is made in particular in the process of 10 to 30% by weight of component A1), 65 to 90% by weight of component A2), 0 to 10% by weight of component A3), 0 to 10% by weight of component A4), 0 to 15% by weight of component A5), 0.1 to 3.0% by weight of C1) (based on pure hydrazine, N₂H₄) and 0 to 10% by weight of C2), the sum of A4) and A5) being 0.1 to 25% by weight and the sum of all the components adding to 100% by weight.

Very particular preference is given to using in the process 8 to 27% by weight of component A1), 65 to 85% by weight of component A2), 0 to 8% by weight of component A3), 0 to 10% by weight of component A4), 0 to 15% by weight of component A5), 1.0 to 2.5% by weight of C1) (based on pure hydrazine, N₂H₄) and 0 to 8% by weight of C2), the sum of A4) and A5) being 0.1 to 25% by weight and the sum of the components adding to 100% by weight.

The process for preparing the aqueous PU dispersions can be carried out in one or more stages in homogeneous phase or, in the case of multi-stage reaction, partly in disperse phase. Following complete or partial polyaddition of A1)-A5) there is a dispersing, emulsifying or dissolving step. This is followed optionally by a further polyaddition or modification in disperse phase.

The aqueous PU dispersions can be prepared using the prior art acetone method or modifications thereof. A summary of these methods is given in Methoden der organischen Chemie (Houben-Weyl, Additional and Supplementary Volumes to the 4th Edition, Volume E20, H. Bartl and J. Falbe, Stuttgart, New York, Thieme 1987, pp. 1671-1682). The acetone method is preferred.

Usually in step A) of the process the constituents A2) to A5), which should not contain any primary or secondary amino groups, and the polyisocyanate component A1), for the preparation of a polyurethane prepolymer, are introduced in whole or in part as an initial charge and are diluted optionally with a water-miscible but isocyanato-inert solvent A6) and heated to elevated temperatures, preferably in the range from 50 to 120° C.

Suitable solvents are the usual aliphatic keto-finctional solvents such as acetone or butanone, for example, which can be added not only at the beginning of the preparation but also in portions later on if desired. Acetone and butanone are preferred. It is possible to carry out the reaction under atmospheric pressure or elevated pressure, e.g., above the atmospheric-pressure boiling temperature of a solvent such as, say, acetone.

It is also possible in the process to include the catalysts known to accelerate the isocyanate addition reaction, such as triethylamine, 1,4-diazabicyclo[2.2.2]octane, dibutyltin oxide, tin dioctoate or dibutyltin dilaurate, tin bis(2-ethylhexanoate) or other organometallic compounds, in the initial charge or to meter them in subsequently. Dibutyltin dilaurate is preferred.

Subsequently any constituents from A1)-A5) not added at the beginning of the reaction are metered in.

In the case of the preparation of the polyurethane prepolymer in step A) the molar ratio of isocyanate groups to isocyanate-reactive groups is 1.0 to 3.5, preferably 1.1 to 3.0, more preferably 1.1 to 2.5.

The reaction of components A1)-A5) to the prepolymer is partial or complete, but preferably complete. The degree of reaction is typically monitored by following the NCO content of the reaction mixture. This can be undertaken using not only spectroscopic measurements, e.g. infrared or near-infrared spectra, but also by determination of the refractive index or by chemical analyses, such as titrations, on samples taken. In this way polyurethane prepolymers containing free isocyanate groups are obtained, as the product per se or in solution.

The preparation of the polyurethane prepolymers from A1) and A2) to A5) is followed or accompanied, if it has not already been carried out in the starting molecules, by partial or complete salt formation from the anionically and/or cationically dispersing groups. In the case of anionic groups this is done using bases such as ammonia, ammonium carbonate or ammonium hydrogencarbonate, trimethylamine, triethylamine, tributylamine, diisopropylethylamine, dimethylethanolamine, diethylethanolamine, triethanolamine, potassium hydroxide or sodium carbonate, preferably triethylamine, triethanolamine, dimethylethanolamine or diisopropylethylamine.

The molar amount of the bases is between 50 and 100%, preferably between 60 and 90% of the molar amount of the anionic groups. In the case of cationic groups, dimethyl sulphate or succinic acid is used. If only nonionically hydrophilicized compounds A5) containing ether groups are used, the neutralization step is omitted. Neutralization may also take place simultaneously with dispersing, with the dispersing water already containing the neutralizing agent.

Subsequently, in a further step B) of the process, if it has not already taken place, or has taken place only partially, in A), the resulting prepolymer is dissolved by means of aliphatic ketones such as acetone or butanone.

In step C) of the process component C I) and also possible NH₂- and/or NH-functional components C2) are reacted with the remaining isocyanate groups. This chain extension/termination may be carried out either in solvent prior to dispersing, in the course of dispersing, or in water after dispersing.

If chain extension in C2) is carried out using compounds meeting the definition of A4) and containing NH₂ or NH groups, the prepolymers are chain extended preferably prior to dispersing.

The degree of chain extension, in other words the equivalent ratio of NCO-reactive groups of the compounds used for chain extension in C1) and optionally C2) to free NCO groups of the prepolymer, is usually between 40-200%, preferably between 70-180%, more preferably between 80-160% and very preferably between 101-150%, with C1) being added in an amount such that at least 40%, preferably at least 50% and more preferably at least 70% of the NCO groups have undergone reaction with compounds of component C1).

The termination of the prepolymer, as well, it is possible in C2) to make use additionally of monoamines such as diethylamine, dibutylamine, ethanolamine, N-methylethanolamine or N,N-diethanolamine, for example.

The aminic components C1) and optionally C2) can optionally be used in water- or solvent-diluted form in the process of the invention, individually or in mixtures, with any order of the addition being possible in principle.

If water or organic solvents are used as diluents then the diluent content is preferably 70 to 95% by weight.

For chain extension it is preferred to add component C1) with the compounds from C2) meeting the definition of A4) and only then to add the compounds from C2) meeting the definitions of A2) and/or A3).

The preparation of the PU dispersions from the prepolymers normally takes place following chain extension (step C)). For that purpose the -dissolved and chain-extended polyurethane polymer is introduced into the dispersing water with strong shearing if desired, such as strong stirring, for example, or, conversely, the dispersing water is stirred into the prepolymer solutions. It is preferred to add the water to the dissolved prepolymer.

In principle it is possible after the dispersing step to carry out further chain extension by adding additional amounts of C1) and C2), but preferably chain extension is carried out exclusively prior to dispersing.

The solvent still present in the dispersions after the dispersing step is normally then removed by distillation. Removal actually during dispersing is likewise possible.

The dispersions obtained in this way have a solids content of 10 to 70% by weight, preferably 25 to 65% by weight and more preferably 30 to 65% by weight.

Depending on the degree of neutralization and amount of ionic groups it is possible to make the dispersion very fine, so that it almost has the appearance of a solution, although very coarse formulations are also possible, and are likewise sufficiently stable.

Moreover it is possible to modify, using polyacrylates, the aqueous PU dispersions obtainable. For that purpose an emulsion polymerization of olefinically unsaturated monomers, examples being esters of (meth)acrylic acid and alcohols having 1 to 18 carbon atoms, styrene, vinyl esters or butadiene, is carried out in these polyurethane dispersions, as described for example in DE-A19 53 348, EP-A0 167 188, EP-A0 189 945 andEP-A0 308 115.

Besides one or more olefinic double bonds, these monomers may also contain functional groups such as hydroxyl, epoxy, methylol or acetoacetoxy groups.

Suitable film-forming resins of component II) are the polymers known per se to the skilled person which are soluble, emulsifiable or dispersible in water. Examples are polyester polymers or epoxy-functional polyester polymers, polyurethanes, acrylic polymers, vinyl polymers such as polyvinyl acetate, polyurethane dispersions, polyacrylate dispersions, polyurethane-polyacrylate hybrid dispersions, polyvinyl ether and/or polyvinyl ester dispersions, polystyrene and/or polyacrylonitrile dispersions. The solids content of the film-forming resins is typically 10 to 95% by weight, preferably 30 to 95% by weight.

The PU dispersions of component I) and the film-forming resins of component II) may contain groups which are reactive towards the crosslinker component III).

As crosslinkers of component III) it is possible to use polyisocyanates with optionally blocked NCO groups and/or amino crosslinker resins such as melamine resins, for example.

Preference is given to using hydrophilic or hydrophilicized water-soluble or water-dispersible blocked polyisocyanates in crosslinker component III).

In one preferred embodiment of the invention, in addition to component I), at least one crosslinker and/or film-forming resin is used.

As component IV) auxiliaries and additives are added to the size compositions. These may be coupling agents, lubricants, antistats or else the coatings additives known well per se to the skilled person, such as dyes, pigments, flow assistants, light stabilizers, aging inhibitors, UV absorbers and so on. An overview of these is given in K. L. Loewenstein “The Manufacturing Technology of Continuous Glass Fibres”, Elsevier Scientific Publishing Corp., Amsterdam, London, New York, 1983, page 243-295.

As coupling agents it is possible in IV) the known silane coupling agents such as 3-aminopropyltrimethoxy- and/or -triethoxysilane, N-(2-aminoethyl)-3-aminopropyltrimethoxysilane, 3-glycidylpropyltrimethoxysilane, vinyltrimethoxysilane, vinyltriethoxysilane or 3-methacryloyloxypropyltriethoxysilane. The concentration of the silane coupling agents in the size compositions of the invention is preferably 0.05 to 2% by weight, more preferably 0.15 to 0.85% by weight, based on the size composition as a whole.

The size compositions of the invention may further comprise one or more nonionic and/or ionic lubricants as part of component IV), such as polyalkylene glycol ethers of fatty alcohols or fatty amines, polyalkylene glycol ethers and glyceryl esters of fatty acids having 12 to 18 carbon atoms, polyalkylene glycols, higher fatty acid amides having 12 to 18 carbon atoms of polyalkylene glycols and/or alkyleneamines, quaternary nitrogen compounds, e.g. ethoxylated imidazolinium salts, mineral oils and waxes. The lubricant or lubricants are employed preferably in a total concentration of 0.05 and 1.5% by weight, based on the size composition as a whole.

The size compositions of the invention may also include one or more antistats as part of component IV). Examples that may be mentioned include lithium chloride, ammonium chloride, Cr(III) salts, organic titanium compounds, arylalkyl sulphates or sulphonates, aryl polyglycol ether sulphonates or quaternary nitrogen compounds. The antistats are employed preferably in concentrations of from 0.01 to 0.8% by weight.

The size compositions can be prepared by the methods known per se. Preferably water is charged to a suitable mixing vessel and, with stirring, the binder (component I)), the curing agent (component III)) and then the lubricant and any further auxiliaries from component IV) are added. Thereafter the pH is adjusted to 5-7 and a hydrolysate of a coupling agent from component IV) is added. After a further stirring time of 15 minutes the size composition is ready to be used and can be applied following pH adjustment where appropriate.

The size compositions can be applied to a suitable substrate and cured thereon by any desired methods, such as by means of spray applicators or roll applicators, for example.

Suitable substrates are selected for example from the group consisting of metal, wood, glass, glass fibres, carbon fibres, stone, ceramic minerals, concrete, hard and flexible plastics of a wide variety of kinds, woven and non-woven textiles, leather, paper, hard fibres, straw and bitumen which may also have been provided, where appropriate, with customary primers prior to sizing. Preferred substrates are glass fibres, carbon fibres, metals, textiles and leather. Particularly preferred substrates are glass fibres.

Glass types suitable for the sized glass fibres include not only the known glass types used for fibreglass manufacture, such as E, A, C, and S glass in accordance with DIN 1259-1, but also the other, conventional products of the glass fibre producers. Among the types of glass mentioned, the E glass fibres possess the greatest importance for the production of continuous glass fibres, to reinforce plastics, owing to their freedom from alkali, their high tensile strength and their high modulus of elasticity.

The method of production, the method of sizing and the subsequent processing of the glass fibres is known and is described in, for example, K. L. Loewenstein “The Manufacturing Technology of Continuous Glass Fibres”, Elsevier Scientific Publishing Corp., Amsterdam, London, New York, 1983.

The sizes are normally applied to the glass filaments, drawn at high speed from spinnerets, immediately following the solidification of the said filaments, i.e. even before they are wound up. An alternative option, however, is to size the fibres in a dip bath, following the spinning operation. The sized glass fibres can be processed either wet or dry to give, for example, chopped glass. The end product or intermediate is dried at temperatures between 50 to 200° C., preferably 90 to 150° C. Drying in this context means not only the removal of other volatile constituents but also, for example, the solidification of the size constituents. Only after drying is at an end has the size become the finished coating material. The fraction of the size, based on the sized glass fibres, is preferably 0.1 to 5.0% by weight, more preferably 0.1 to 3.0% by weight and very preferably 0.3 to 1.5% by weight.

As matrix polymers into which the sized glass fibres thus produced can be incorporated it is possible to use a multiplicity of thermoplastics and polymers which can be cured to thermosets. Examples of suitable thermoplastic polymers include the following: polyolefins such as polyethylene or polypropylene, polyvinyl chloride, polymers such as styrene/acrylonitrile copolymers, ABS, polymethacrylate or polyoxymethylene, aromatic and/or aliphatic polyamides such as polyamide-6 or polyamide-6,6, polycondensates such as polycarbonate, polyethylene terephthalate, liquid-crystalline polyaryl esters, polyarylene oxide, polysulphone, polyarylene sulphide, polyaryl sulphone, polyether sulphone, polyaryl ethers or polyether ketone or polyadducts such as polyurethanes. Examples that may be mentioned of polymers which can be cured to thermosets include the following: epoxy resins, unsaturated polyester resins, phenolic resins, amine resins, polyurethane resins, polyisocyanurates, epoxy/isocyanurate combination resins, furan resins, cyanurate resins and bismaleimide resins.

### EXAMPLES

Unless indicated otherwise, all percentages are to be understood as referring to per cent by weight.

Diaminosulphonate:

NH₂—CH₂CH₂—NH—CH₂CH₂—SO₃Na (45% in water)

The solids contents were determined in accordance with DIN-EN ISO 3251. Unless expressly mentioned otherwise, NCO contents were determined volumetrically in accordance with DIN-EN ISO 11909. The yellowness indices were determined by means of the CIELAB method (DIN 5033).

Crosslinker Dispersion:

147.4 g of a polyisocyanate containing biuret groups and based on 1,6-diisocyanatohexane (HDI), with an NCO content of 23.0%, were introduced as an initial charge at 40° C. Over the course of 10 minutes 121.0 g of polyether-LB 25 (monofunctional polyether based on ethylene oxide/propylene oxide with a number-average molecular weight of 2250 g/mol, an OH number of 25 mg KOH/g, Bayer AG, Leverkusen, DE) were metered in with stirring. The reaction mixture was then heated to 90° C. and was stirred at this temperature until the theoretical NCO value was attained. After the reaction mixture had been cooled to 65° C., 62.8 g of butanone oxime were added dropwise with stirring over the course of 30 minutes at a rate such that the temperature of the mixture did not exceed 80° C. Dispersing took place subsequently by addition of 726.0 g of water (T=20° C.) at 60° C. over the course of 30 minutes. The subsequent stirring time at 40° C. was 1 h.

This gave a storage-stable aqueous dispersion of the blocked polyisocyanate with a solids content of 30.0%.

### Example 1

### Comparative Example

Baybond® PU 401 (anionically and nonionically hydrophilicized PU dispersion with a solids content of 40% and a mean particle size of 100-300 nm, Bayer AG, Leverkusen, DE)

### Example 2

306.0 g of polyester PE 170 HN (polyester polyol, OH number 66 mg KOH/g, number-average molecular weight 1700 g/mol, Bayer AG, Leverkusen, DE), 13.5 g of polyether LB 25 (monofunctional polyether based on ethylene oxide/propylene oxide with a number-average molecular weight of 2250 g/mol, OH number 25 mg KOH/g, Bayer AG, Leverkusen, DE) and 0.1 g of Desmorapid® Z (dibutyltin dilaurate, Bayer AG, Leverkusen, DE) were heated to 65° C. Subsequently a mixture of 91.0 g of isophorone diisocyanate and 71.0 g of acetone was added over the course of 5 minutes at 65° C. and the mixture was stirred at reflux until the theoretical NCO value was reached. The finished prepolymer was dissolved in 353.2 g of acetone at 50° C. and then a solution of 12.4 g of hydrazine hydrate and 40.5 g of water was metered in over the course of 10 minutes. Following the addition of 17.7 g of diaminosulphonate over the course of 5 minutes, stirring was continued for 15 minutes and then the batch was dispersed by adding 584.9 g of water over the course of 10 minutes. Thereafter the solvent was removed by vacuum distillation to give a storage-stable dispersion having a solids content of 40.0%.

### Example 3

1530.0 g of polyester PE 170 (polyester polyol, OH number 66 mg KOH/g, number-average molecular weight 1700 g/mol, Bayer AG, Leverkusen, DE), 67.5 g of polyether LB 25 (monofunctional polyether based on ethylene oxide/propylene oxide with a number-average molecular weight of 2250 g/mol, OH number 25 mg KOH/g, Bayer AG, Leverkusen, DE) and 0.1 g of Desmorapid® Z (dibutyltin dilaurate, Bayer AG, Leverkusen, DE) were heated to 65° C. Subsequently a mixture of 537.1 g of Desmodur® W (bis(4,4′-isocyanatocyclohexyl)methane, Bayer AG, Leverkusen, DE) and 355.0 g of acetone was added over the course of 5 minutes at 65° C. and the mixture was stirred at reflux until the theoretical NCO value was reached. The finished prepolymer was dissolved with 1766.0 g of acetone at 50° C. and then a solution of 50.0 g of hydrazine hydrate, 51.0 g of isophoronediamine and 401.3 g of water was metered in over the course of 10 minutes. Following the addition of 63.3 g of diaminosulphonate over the course of 5 minutes, stirring was continued for 15 minutes and then the batch was dispersed by adding 2915.0 g of water over the course of 10 minutes. Thereafter the solvent was removed by vacuum distillation to give a storage-stable dispersion having a solids content of 40.0%.

### Example 4

1468.8 g of polyester PE 170 HN (polyester polyol, OH number 66 mg KOH/g, number-average molecular weight 1700 g/mol, Bayer AG, Leverkusen, DE), 64.8 g of polyether LB 25 (monofunctional polyether based on ethylene oxide/propylene oxide with a number-average molecular weight of 2250 g/mol OH number 25 mg KOH/g, Bayer AG, Leverkusen, DE) and 0.1 g of Desmorapid® Z (dibutyltin dilaurate, Bayer AG, Leverkus en, DE) were heated to 65° C. Subsequently a mixture of 436.9 g of isophorone diisocyanate and 340.8 g of acetone was added over the course of 5 minute's at 65° C. and the mixture was stirred at reflux until the theoretical NCO value was reached. The finished prepolymer was dissolved with 1695.4 g of acetone at 50° C. and then a solution of 55.2 g of hydrazine hydrate, 24.5 g of isophoronediamine and 319.0 g of water was metered in over the course of 10 minutes. Following the addition of 60.8 g of diaminosulphonate over the course of 5 minutes, stirring was continued for 15 minutes and then the batch was dispersed by adding 2714.1 g of water over the course of 10 minutes. Thereafter the solvent was removed by vacuum distillation to give a storage-stable dispersion having a solids content of 40.0%.

### Example 5

1453.5 g of polyester PE 170 HN (polyester polyol, OH number 66 mg KOH/g, number-average molecular weight 1700 g/mol, Bayer AG, Leverkusen, DE), 64.1 g of polyether LB 25 (monofunctional polyether based on ethylene oxide/propylene oxide with a number-average molecular weight of 2250 g/mol, OH number 25 mg KOH/g, Bayer AG, Leverkusen, DE) and 0.1 g of Desmorapid® Z (dibutyltin dilaurate, Bayer AG, Leverkusen, DE) were heated to 65° C. Subsequently a mixture of 432.3 g of isophorone diisocyanate and 343.9 g of acetone was added over the course of 5 minutes at 65° C. and the mixture was stirred at reflux until the theoretical NCO value was reached. The finished prepolymer was dissolved with 2298.5 g of acetone at 50° C. and then a solution of 40.6 g of hydrazine hydrate, 48.5 g of isophoronediamine and 421.1 g of water was metered in over the course of 10 minutes. Following the addition of 60.1 g of diaminosulphonate over the course of 5 minutes, stirring was continued for 15 minutes and then the batch was dispersed by adding 2608.4 g of water over the course of 10 minutes. Thereafter the solvent was removed by vacuum distillation to give a storage-stable dispersion having a solids content of 40.0%.

### Example 6

1499.4 g of polyester PE 170 HN (polyester polyol, OH number 66 mg KOH/g, number-average molecular weight 1700 g/mol, Bayer AG, Leverkusen, DE), 66.2 g of polyether LB 25 (monofunctional polyether based on ethylene oxide/propylene oxide with a number-average molecular weight of 2250 g/mol, OH number 25 mg KOH/g, Bayer AG, Leverkusen, DE) and 0.1 g of Desmorapid® Z (dibutyltin dilaurate, Bayer AG, Leverkusen, DE) were heated to 65° C. Subsequently a mixture of 446.0 g of isophorone diisocyanate and 355.0 g of acetone was added over the course of 5 minutes at 65° C. and the mixture was stirred at reflux until the theoretical NCO value was reached (determined via near-infrared (NIR) spectroscopy inline). The finished prepolymer was dissolved with 1766.0 g of acetone at 50° C. and then a solution of 49.0 g of hydrazine hydrate, 50.0 g of isophoronediamine and 443.0 g of water was metered in over the course of 10 minutes. Following the addition of 62.0 g of diaminosulphonate over the course of 5 minutes, stirring was continued for 15 minutes and then the batch was dispersed by adding 2686.1 g of water over the course of 90 minutes. The dispersing step was accompanied by removal of the solvent by parallel, vacuum distillation to give a storage-stable dispersion having a solids content of 40.0%.

### Example 7

342.0 g of polyTHF 2000 (polyether based on tetrahydrofuran, OH number 56 mg KOH/g, number-average molecular weight 2000 g/mol), 16.7 g of polyether LB 25 (monofunctional polyether based on ethylene oxide/propylene oxide with a number-average molecular weight of 2250 g/mol, OH number 25 mg KOH/g, Bayer AG, Leverkusen, DE) and 0.1 g of Desmorapid® Z (dibutyltin dilaurate, Bayer AG, Leverkusen, DE) were heated to 65° C. Subsequently a mixture of 86.5 g of isophorone diisocyanate and 67.5 g of acetone was added over the course of 5 minutes at 65° C. and the mixture was stirred at reflux until the theoretical NCO value was reached. The finished prepolymer was dissolved with 335.5 g of acetone at 50° C. and then a solution of 9.2 g of hydrazine hydrate, 9.4 g of isophoronediamine and 73.7 g of water was metered in over the course of 10 minutes. Following the addition of 15.0 g of diaminosulphonate over the course of 5 minutes, stirring was continued for 15 minutes and then the batch was dispersed by adding 615.4 g of water over the course of 10 minutes. Thereafter the solvent was removed by vacuum distillation to give a storage-stable dispersion having a solids content of 40.0%.

### Example 8

### Comparative Example

Aqueous polyurethane dispersion according to DE-A 32 38 169, Example 2, prepared via prepolymer mixing method. Chain extension was carried out again with hydrazine hydrate.

### Example 9

### Comparative Example

Aqueous polyurethane dispersion prepared according to U.S. Pat. No. 5,137,967, Example 1, likewise by the prepolymer mixing method and with chain extension with hydrazine hydrate.

### Application Examples

Table 1 shows the size compositions in detail. The compositions were prepared as follows: in a mixing vessel half of the stated amount of water was introduced and, with stirring and in succession, the inventive PU dispersions, film-forming resins, crosslinker dispersion and lubricant (Breox® 50-A140, BP-Chemicals, GB) were added. Thereafter the pH was adjusted to 5-7 using acetic acid and a hydrolysate of 3-aminopropyltriethoxysilane (A1100, UCC, New York, USA), prepared according to the manufacturer's specifications, was added as an aqueous coupling agent solution. After a further stirring time of 15 minutes the size was ready to be used.

Subsequently, following adjustment of the pH to 5-7 where appropriate, the size compositions were applied to glass fibres. The glass fibres thus sized were subsequently chopped and dried.

| | Size 1 | | | | | | | Size 8** | Size 9** |
|---|---|---|---|---|---|---|---|---|---|
| | comparative | Size 2 | Size 3 | Size 4 | Size 5 | Size 6 | Size 7 | comparative | comparative |
| Water | 42.0 kg | 42.0 kg | 42.0 kg | 42.0 kg | 42.0 kg | 42.0 kg | 42.0 kg | 42.0 kg | 42.0 kg |
| PU dispersion | 11.5 kg | 11.5 kg | 11.5 kg | 11.5 kg | 11.5 kg | 11.5 kg | 11.5 kg | 11.5 kg | 11.5 kg |
| | Example 1 | Example 2 | Example 3 | Example 4 | Example 5 | Example 6 | Example 7 | Example 8 | Example 9 |
| Crosslinker | 3.5 kg | 3.5 kg | 3.5 kg | 3.5 kg | 3.5 kg | 3.5 kg | 3.5 kg | 3.5 kg | 3.5 kg |
| dispersion | | | | | | | | | |
| Coupling agent | 0.6 kg | 0.6 kg | 0.6 kg | 0.6 kg | 0.6 kg | 0.6 kg | 0.6 kg | 0.6 kg | 0.6 kg |
| Lubricant | 0.4 kg | 0.4 kg | 0.4 kg | 0.4 kg | 0.4 kg | 0.4 kg | 0.4 kg | 0.4 kg | 0.4 kg |
| Water | 42.0 kg | 42.0 kg | 42.0 kg | 42.0 kg | 42.0 kg | 42.0 kg | 42.0 kg | 42.0 kg | 42.0 kg |
| Total | 100.0 kg | 100.0 kg | 100.0 kg | 100.0 kg | 100.0 kg | 100.0 kg | 100.0 kg | 100.0 kg | 100.0 kg |
| Yellowness index | 61 | 53 | 55 | 53 | 51 | 50 | 56 | 63 | 67 |
| [YI]* | | | | | | | | | |

*relates to the chopped, dried glass fibres prepared with the respective size
**during the preparation of the size the coupling agent A1100 was used directly; the preparation of a hydrolysate was omitted

The yellowness indices found, as a measure of the yellowing of the sized glass fibres, demonstrate that the glass fibres sized with the size compositions of the invention exhibit significantly lower thermal yellowing than the glass fibres produced with the prior art size compositions.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Size compositions comprising
I) one or more polyurethane-polyurea dispersions (PU dispersions);
II) optionally further film-forming resins; and
III) optionally crosslinkers;
IV) auxiliaries and additives;
wherein the PU dispersions in I) are obtained by
A) preparing an NCO-containing polyurethane prepolymer by reacting
A1) polyisocyanates with
A2) polymeric polyols and/or polyamines having number-average molecular weights of 400 to 8000 g/mol,
A3) optionally low molecular weight compounds having number-average molecular weights of 17-400 g/mol selected from the group consisting of mono- and polyalcohols, mono- and polyamines and also amino alcohols,
A4) isocyanate-reactive, ionically or potentially ionically hydrophilicizing compounds and/or
A5) isocyanate-reactive nonionically hydrophilicizing compounds
A6) optionally in inert solvents
with the proviso that none of components A1) to A5) contains primary or secondary amino groups,
B) either dissolving the prepolymer obtained from step A) in aliphatic ketones or, diluting the prepolymer solution if preparation has already been carried out in inert solvents, optionally by further addition of aliphatic ketones, and
C) reacting the remaining free NCO groups of the prepolymer with a chain extender component comprising
C1) hydrazine and/or hydrazine hydrate and
C2) optionally compounds meeting the definition of components A2), A3), A4) and/or A5),
with the proviso that
the compounds of component C2) contain primary and/or secondary amino groups,
the total amounts of C1) and C2) are such that an arithmetic degree of chain extension of 40 to 200% is attained and
the proportion of C1) and C2) is such that at least 40% of the free isocyanate groups are terminated by and/or chain-extended with amino groups from component C1).

2. The size compositions according to claim 1, wherein the PU dispersions in step B) and optionally step A) are prepared using acetone or butanone as solvent.

3. The size compositions according to claim 1, wherein the PU dispersions in steps A)-C) comprise 8 to 27% by weight of component A1), 65 to 85% by weight of component A2), 0 to 8% by weight of component A3), 0 to 10% by weight of component A4), 0 to 15% by weight of component A5), 1.0 to 2.5% by weight of C1) (based on pure hydrazine, N₂H₄), and 0 to 8% by weight of C2), the sum of A4) and A5) being 0.1 to 25% by weight and the sum of the components adding to 100% by weight.

4. The size compositions according to claim 1, wherein the PU dispersions are prepared such that the amounts of C1) and C2) are such that an arithmetic degree of chain extension of 101-150% results.

5. Mouldings and/or coatings comprising the size compositions according to claim 1 and one or more additives selected from the group consisting of coupling agents, lubricants, antistats, dyes, pigments, flow assistants, light stabilizers, aging inhibitors, UV absorbers, and combinations thereof.

6. Substrates coated with coatings produced using size compositions according to claim 1.

7. Glass fibres comprising the size compositions according to claim 1 applied to the glass fibers.

8. The Glass fibres according to claim 7, wherein the size compositions are applied to glass filaments, drawn at high speed from spinnerets, immediately following solidification of the said filaments.

9. The Glass fibres according to claim 7, wherein the size compositions are applied to glass filaments in a dip bath, following a spinning operation.

10. The size compositions according to claim 1 further comprising one or more additives selected from the group consisting of coupling agents, lubricants, antistats, dyes, pigments, flow assistants, light stabilizers, aging inhibitors, UV absorbers, and combinations thereof.

11. The size compositions according to claim 2, wherein the PU dispersions in steps A)-C) comprise 8 to 27% by weight of component A1), 65 to 85% by weight of component A2), 0 to 8% by weight of component A3), 0 to 10% by weight of component A4), 0 to 15% by weight of component A5), 1.0 to 2.5% by weight of C1) (based on pure hydrazine, N₂H₄), and 0 to 8% by weight of C2), the sum of A4) and A5)being 0.1 to 25% by weight and the sum of the components adding to 100% by weight.

12. Substrates coated with coatings produced using size compositions according to claim 2.

13. Glass fibres comprising the size compositions according to claim 2 applied to the glass fibers.

14. The Glass fibres according to claim 13, wherein the size compositions are applied to glass filaments, drawn at high speed from spinnerets, immediately following solidification of the said filaments.

15. The Glass fibres according to claim 13, wherein the size compositions are applied to glass filaments in a dip bath, following a spinning operation.

16. Substrates coated with coatings produced using size compositions according to claim 3.

17. Glass fibres comprising the size compositions according to claim 3 applied to the glass fibers.

18. The Glass fibres according to claim 17, wherein the size compositions are applied to glass filaments, drawn at high speed from spinnerets, immediately following solidification of the said filaments.

19. The Glass fibres according to claim 17, wherein the size compositions are applied to glass filaments in a dip bath, following a spinning operation.
